(19) United States
(12) Patent Application Publication
(10) Pub. No.: US 2015/0280582 A1
(43) Pub. Date: Oct. 1, 2015

(54) RESONANCE DC/DC CONVERTER

(71) Applicant: KABUSHIKI KAISHA TOYOTA JIDOSHOKKI, Kariya-shi (JP)

(72) Inventors: Hiroo FUMA, Nagakute-shi (JP); Takaji UMENO, Nagakute-shi (JP); Yoshiro KATO, Kariya-shi (JP); Yoshiaki ISHIHARA, Kariya-shi (JP); Sergey MOISEEV, Kariya-shi (JP)

(73) Assignee: KABUSHIKI KAISHA TOYOTA JIDOSHOKKI, Kariya-shi (JP)

(21) Appl. No.: 14/669,737

(22) Filed: Mar. 26, 2015

(30) Foreign Application Priority Data
Mar. 27, 2014 (JP) 2014-065918

(51) Int. Cl. H02M 3/335

(52) U.S. Cl. CPC H02M 3/33507

(57) ABSTRACT

In a resonance DC/DC converter, an input circuit has a configuration including a DC power source, a resonance auxiliary coil, a primary-side coil, a switching element connected in series, and a rectifying element and a resonance capacitor connected to the switching element in parallel. Here, there are provided an inductance value shifting circuit configured to shift an inductance value of the resonance auxiliary coil, and a control device configured to control the inductance value shifting circuit and shift the inductance value of the resonance auxiliary coil in accordance with a voltage value of the DC power source so that a voltage across the primary-side coil becomes constant.

### RELATED APPLICATIONS

This application claims priority to Japanese Patent Application No. 2014-065918, filed on Mar. 27, 2014, the entire disclosure of which is incorporated herein by reference.

### BACKGROUND OF THE INVENTION

1. Field of the Invention

The present invention relates to a resonance DC/DC converter.

2. Description of the Related Art

A DC/DC converter for converting a direct voltage is used in a mechanical apparatus using a rotating electrical machine; for example, electric vehicles such as hybrid vehicles, industrial robots, machine tools, and elevators. The DC/DC converter includes that of an insulation type resonance operation method in which electric power is converted via a transformer, which is referred to as a resonance DC/DC converter. In this system, an output voltage of a primary-side DC power source is converted into an AC signal by using an electromagnetic induction and resonance, is stepped up or down at a ratio of the number of turns of the transformer, and then a secondary-side AC signal is returned back to a DC signal and is supplied to a load.

For example, U.S. Pat. No. 6,344,979 discloses an LLC series resonance DC/DC converter including a rectangular signal generating circuit composed of a DC power source and a switching circuit on a primary side of a transformer, a capacitor Cs and an inductor Ls connected to a point between an output terminal of the rectangular signal generating circuit and one side terminal of a primary side coil of the transformer in series, and an inductor Lm connected to a point between the one side terminal of the primary-side coil and a ground terminal on the other side in parallel.

In contrast with U.S. Pat. No. 6,344,979, JP-A-2013-158168 discloses a single switch resonance DC/DC converter which does not require the rectangular signal generating circuit and includes one switching transistor instead. In JP-A-2013-158168, one end of an auxiliary inductor is connected to a positive terminal of a primary-side power supply source, and the other end of the auxiliary inductor is connected to one end of a primary side inductor of a transformer. The other end of the primary-side power supply source is connected to one end of a switching element, and the other end of the switching element is connected to a negative terminal of the power supply source. A resonance capacitor is connected to the switching element in parallel, and a diode having an anode terminal at the negative terminal of the power supply source is connected to the switching element in parallel.

When compared with the LLC resonance DC/DC converter provided with the rectangular wave signal generator of U.S. Pat. No. 6,344,979, the single switch resonance DC/DC converter of JP-A-2013-158168 is expected to be operated at higher frequencies. Since the resonance DC/DC converter uses LC resonance, it is expected that an apparent L is shifted by a load variation and hence a resonance frequency varies, whereby an operating point varies. In a step-down converter for vehicles, input voltage specifications may range from 100 V to 300 V. If the input voltage varies in a wide range as described above, an output voltage varies, and a load variation results. For these reasons, in a high-frequency operation, a resonance DC/DC converter that is little affected by an input voltage variation and a load variation is desired.

### SUMMARY OF THE INVENTION

An object of the invention is to provide a resonance DC/DC converter that is little affected by an input voltage variation and a load variation in a high-frequency operation.

A resonance DC/DC converter of the invention is a resonance DC/DC converter including a transformer in which a primary-side coil of an input circuit including an LC resonance circuit and a secondary-side coil of an output circuit are magnetically coupled, wherein the input circuit includes: a DC power source having a grounded negative terminal and a positive terminal; a resonance auxiliary coil connected in series to a point between the positive terminal of the DC power source and one side terminal of the primary-side coil; a switching element having one switching side terminal connected to the other terminal of the primary-side coil, another switching side terminal, which is connected to ground, and a control terminal; a rectifying element having a cathode terminal connected to the one switching side terminal of the switching element and an anode terminal connected to the other switching side terminal of the switching element; a resonance capacitor connected to the one switching side terminal and the other switching side terminal of the switching element in parallel; an inductance value shifting device configured to shift an inductance value of the resonance auxiliary coil; and a control circuit configured to control the inductance value shifting device and shift the inductance value of the resonance auxiliary coil in accordance with a voltage value of the DC power source so that a voltage across the primary-side coil is kept constant.

Preferably, the inductance value shifting device is configured to connect one side terminal of each of a plurality of coils commonly to the resonance auxiliary coil or the primary-side coil, connect the other side terminal of one coil to a positive side of the DC power source and connect a capacitor and a change-over switch in series to the other side terminals of the remaining coils respectively and then to the ground, so that the voltage of the DC power source is applied to the capacitor when the change-over switch is ON, whereby the coil connected to the change-over switch is equivalently connected to the DC power source in parallel.

Preferably, the input circuit and the output circuit have a two-phase configuration, and the inductance value shifting device magnetically couples the resonance auxiliary coils of the input circuits of the respective phases to each other, and shifts an equivalent inductance value of the resonance auxiliary coil by switching a phase difference of the input signals of the switching elements of the input circuits of the respective phases between zero degrees and 180 degrees.

Preferably, the inductance value shifting device is configured in such a manner that the resonance auxiliary coils of the respective phases each have a plurality of coils connected in series, is configured to connect each of connecting points of the plurality of coils to the capacitor and the change-over switch in series and then to the ground, and shift the inductance value among a plurality of values by ON-OFF control of a plurality of the change-over switches.

Preferably, an output voltage from the output circuit is fed back and the frequency of the switching element is changed so that the output voltage becomes constant within a desired output current range, and the inductance value of the resonance auxiliary coil is shifted on the basis of the output current from the output circuit and the input voltage of the input circuit.

The resonance DC/DC converter having the configuration described above includes the transformer in which the primary-side coil of the input circuit including the LC resonance circuit and the secondary-side coil of the output circuit are magnetically coupled. The input circuit has a configuration including the DC power source, the resonance auxiliary coil, the primary-side coil, and the switching element connected in series, the rectifying element and the resonance capacitor connected to the switching element in parallel, and is further configured to allow the inductance value of the resonance auxiliary coil to be shifted. When the voltage of the DC power source varies, an electric current flowing through the primary-side coil and the resonance auxiliary coil varies, and the input voltage to the primary-side coil varies. If the primary-side voltage varies, the transformer can hardly bring the secondary-side voltage to a predetermined voltage. In the configuration described above, the value of the resonance auxiliary coil is changed in accordance with the voltage value of the DC power source so that the voltage across the primary-side coil is kept constant. Therefore, an influence of the input voltage variation may be restrained in operation at high frequency of the resonance DC/DC converter.

In the resonance DC/DC converter, the one side terminals of the plurality of coils are connected commonly to the resonance auxiliary coil or the primary-side coil, the other side terminal of the one coil is connected commonly to the positive side of the DC power source, and the capacitor and the change-over switch are connected in series to the other side terminals of the remaining coils respectively and then to the ground, so that the coil connected to the change-over switch is connected to the DC power source in parallel equivalently when the change-over switch is ON. In this configuration, the value of the resonance auxiliary coil can be shifted in accordance with a voltage value of the DC power source so that voltage across the primary-side coil is kept constant.

In the resonance DC/DC converter, in the case where the input circuit and the output circuit have a two-phase configuration, the resonance auxiliary coils of the input circuits of the respective phases are magnetically coupled to each other, and the phase difference between the drive signals of the switching elements of the input circuits of the respective phases are switched between zero and 180 degrees. Accordingly, the equivalent inductance values of the respective resonance auxiliary coils may be shifted.

In the resonance DC/DC converter having the two-phase configuration, the resonance auxiliary coils of the respective phases each having a plurality of coils connected in series, is configured to connect each of connecting points of the plurality of coils to the capacitor and the change-over switch in series, and then to the ground. Accordingly, when the change-over switch is turned ON, the coil connected thereto serves simply as resistance, so that the inductance value may be shifted among a plurality of values.

In the resonance DC/DC converter, the output voltage from the output circuit is fed back and the frequency of the switching element is changed so that the output voltage becomes constant within a desired output current range, and the inductance value of the resonance auxiliary coil is shifted on the basis of the output current from the output circuit and the input voltage of the input circuit. In this manner, influences of the input voltage variation and the load variation are restrained, and the operation at high frequency of the resonance DC/DC converter is enabled.

### BRIEF DESCRIPTION OF THE DRAWINGS

The present invention will be further described with reference to the accompanying drawings, wherein like reference numerals refer to like parts in the several views, and wherein:

FIG. 1 is a configuration drawing of a resonance DC/DC converter of an embodiment of the invention;

FIGS. 2A to 2D are drawings illustrating a basic operation when an inductance value of a resonance auxiliary coil is not shifted in FIG. 1, in which FIG. 2A is a drawing illustrating a state change of respective elements under a high-frequency operation of a switching element; and FIGS. 2B to 2D are drawings illustrating changes of a flow of an electric current in one cycle of the operation of the switching element;

FIG. 3 is a characteristic drawing of a basic operation of FIGS. 2A to 2D;

FIGS. 4A and 4B are drawings illustrating voltage applied to the resonance auxiliary coil and a primary-side coil when the voltage of a DC power source varies in FIG. 1; in which FIG. 4A illustrates a case where an inductance value of the resonance auxiliary coil is not shifted; and FIG. 4B illustrates a case where the inductance value of the resonance auxiliary coil is shifted;

FIGS. 5A to 5E are drawings illustrating one of examples of the circuit configuration configured to shift the inductance value of the resonance auxiliary coil in the resonance DC/DC converter of the embodiment of the invention, in which FIG. 5A is a general configuration drawing; and FIGS. 5B to 5E illustrate shifting of the inductance value of the resonance auxiliary coil by the operation of a change-over switch;

FIG. 6 is a drawing illustrating one of examples of the circuit configurations of the resonance DC/DC converter of the embodiment for shifting the inductance value of the resonance auxiliary coil in the case of a two-phase configuration;

FIG. 7 is a drawing illustrating another example of the circuit configurations of the resonance DC/DC converter of the embodiment for shifting the inductance value of the resonance auxiliary coil in the case of the two-phase configuration;

FIGS. 8A and 8B are characteristic drawings when the inductance of the resonance auxiliary coil is shifted in four steps in accordance with variations of an input voltage in the configuration illustrated in FIG. 7; and

FIGS. 9A and 9B are characteristic drawings when the inductance of the resonance auxiliary coil is shifted in four steps in accordance with the variations of the input voltage when an output current is larger than that in FIGS. 8A and 8B.

### DETAIL DESCRIPTION OF THE EMBODIMENT

Referring now to the drawings, an embodiment of the invention will be described in detail. In the following description, a resonance DC/DC converter to be mounted on a vehicle will be described. However, it is an example for description only, and may be used for applications other than mounting on the vehicle. Input voltage variation widths, output current variation widths, output voltage values, and inductance values described below are only examples for description, and may be changed as needed in accordance with the specification of the resonance DC/DC converter. In the following description, the same elements in all the drawings are denoted by the same reference numerals, and repeated description will be omitted.

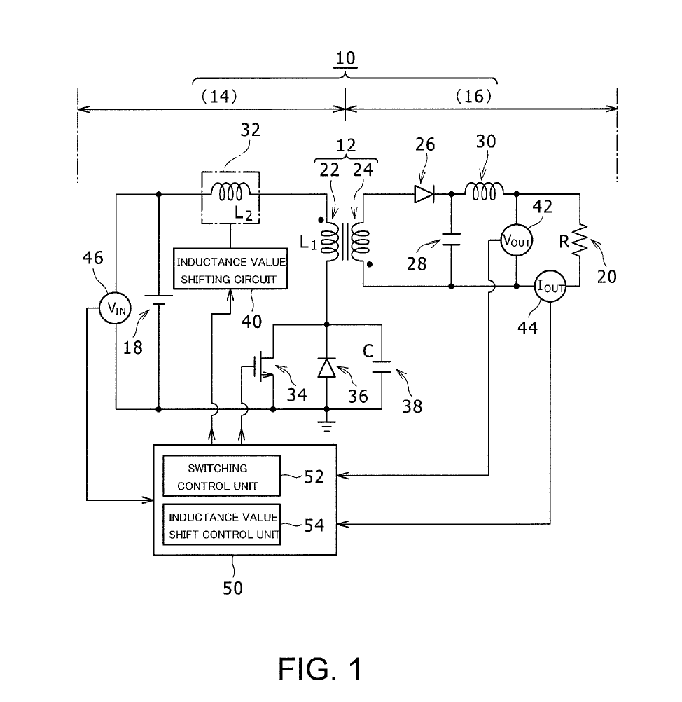

FIG. 1 is a configuration drawing of a resonance DC/DC converter 10. The resonance DC/DC converter 10 is basically a single switch resonance DC/DC converter described in JP-A-2013-158168, and is further provided with a function to shift the inductance value of the resonance auxiliary coil so as to enable the operation in a wider range of input voltage. In the following description, the resonance DC/DC converter 10 is referred to as the converter 10 unless specifically noted.

The converter 10 is an insulating type DC/DC converter of a type converting electric power via a transformer 12 by a voltage converter mounted on the vehicle. The converter 10 includes the transformer 12, an input circuit 14 as a primary side thereof, an output circuit 16 on a secondary side thereof, and a control device 50 configured to control an entire operation. The converter 10 steps down the voltage of a DC power source 18 in the input circuit 14 on the primary side and supplies the stepped-down voltage to a load 20 of the output circuit 16 on the secondary side. The transformer 12 includes a primary-side coil 22 and a secondary side coil 24, and a ratio of voltage step down is determined at ratios of the number of turns thereof. For example, the ratio of the number of turns is determined to be the number of turns on the primary side: the number of turns on the secondary side=7:1, and the voltage of the DC power source 18 is assumed to be approximately 100 V, is stepped down to 15V, which is approximately 1/7, and is supplied to the load 20.

Since characteristic items of the resonance DC/DC converter 10 are in the input circuit 14 on the primary side, a configuration of the output circuit 16 on the secondary side, which has less characteristic items, will be described first. The output circuit 16 on the secondary side is an AC/DC converting circuit configured to rectify and smoothen AC power output from the secondary side coil 24 of the transformer 12, convert the rectified and smoothened power into DC power, and supply the converted voltage to the load 20. Here, a diode 26 has a rectifying function, a capacitor 28 has a smoothening function, and a coil 30 has a filtering function. The load 20 is illustrated as a resistance element in FIG. 1. However, it is a model of various apparatuses and instruments operated with a DC current. The load 20 includes a compact motor, a control circuit, an air-conditioning apparatus, an audio apparatus, and a lighting apparatus mounted on the vehicle.

The input circuit 14 on the primary side has a configuration including the DC power source 18, a resonance auxiliary coil 32, the primary-side coil 22, and a switching element 34 connected in series, a rectifying element 36 and a resonance capacitor 38 connected to the switching element 34 in parallel, and an inductance value shifting circuit 40 configured to shift the inductance value of the resonance auxiliary coil 32.

The DC power source 18 is an electric storage device mounted on the vehicle, and a voltage between terminals thereof is an input voltage V_{IN} of the converter 10, and varies depending on the machine type of the vehicle. For example, the input voltage may vary in a range from approximately 100 V to approximately 300 V depending on the machine type of the vehicle, and the converter 10 includes the inductance value shifting circuit 40 so as to support the variations in input voltage over such a wide range. As illustrated in FIG. 1, a negative terminal of the DC power source 18 is grounded.

The resonance auxiliary coil 32 is an inductor connected between a positive terminal of the DC power source 18 and one side terminal of the primary-side coil 22 in series.

The switching element 34 is a high-voltage high-frequency transistor having a one switching side terminal connected to the other side terminal of the primary-side coil 22, another switching side terminal to be grounded, and a control terminal. In FIG. 1, an n-channel type MOS transistor is illustrated as the switching element 34. Therefore, the switching side terminal to be connected to the primary-side coil 22 is a drain terminal, the other switching side terminal to be grounded is a source terminal, and the control terminal is a gate terminal. The gate terminal serving as the control terminal receives a supply of a control signal from the control device 50, whereby the switching element 34 is turned ON and OFF. Since the maximum value of a voltage between drain sources of the switching element 34 is on the order of 1 KV, and the maximum value of a drain current is on the order of 25 A, for example, a MOSFET having specifications of 1200 V, 30 A offered commercially may be used. Depending on the case, a high-voltage and high-frequency npn-type bipolar transistor having the specifications of the same level may be used.

The rectifying element 36 is a diode having a cathode terminal connected to the one switching side terminal of the switching element 34 and an anode terminal connected to the other switching side terminal of the switching element 34. The one switching side terminal is connected to the other side terminal of the primary-side coil 22, and the other switching side terminal is grounded, so that the rectifying device 36 is arranged between the primary-side coil 22 and the ground.

The resonance capacitor 38 is a capacitor connected to the one switching side terminal and the other switching side terminal of the switching element 34 in parallel. The one switching side terminal is connected to the other side terminal of the primary-side coil 22, and the other switching side terminal is grounded, so that the resonance capacitor 38 is arranged between the primary-side coil 22 and the ground.

In this manner, the switching element 34, the rectifying device 36, and the resonance capacitor 38 are connected and arranged so as to be parallel to each other between the other side terminal of the primary-side coil 22 and the ground.

The resonance auxiliary coil 32 constitutes part of the resonance coil together with the primary-side coil 22, and forms an LC resonance circuit with the resonance coil and the resonance capacitor 38. The resonance frequency of the LC resonance circuit is 1/[2π{(L₁+L₂)C}^{1/2}] where L₂ is an inductance value of the resonance auxiliary coil 32, L₁ is an inductance value of the primary-side coil 22, and C is a capacitance value of the resonance capacitor 38.

The description given above is a basic configuration of the single switch resonance DC/DC converter described in JP-A-2013-158168. The converter 10 in FIG. 1 further includes the inductance value shifting circuit 40 that shifts the inductance value of the resonance auxiliary coil 32 so as to support a wide variation of the converter input voltage V_{IN,} which is the voltage between the terminals of the DC power source 18. The contents will be described below in conjunction with FIG. 4 and onward.

For the operation control of the whole, the converter 10 includes an output voltage detector 42 configured to detect an output voltage V_{OUT} in the output circuit 16 on the secondary side, an output current detector 44 configured to detect an output current I_{OUT} and an input voltage detector 46 configured to detect an input voltage V_{IN} as voltage between terminals of the DC power source 18 in the input circuit 14 on the primary side. The detection values thereof are transmitted to the control device 50 via suitable signal lines.

The control device 50 is an apparatus configured to control the operation of the converter 10 as a whole, and includes a switching control unit 52 and an inductance value shift control unit 54. The control device 50 may be composed of a computer or the like suitable for being mounted on the vehicle.

The switching control unit 52 has a function to change an operation frequency f and a duty ratio A of the switching element 34 of the input circuit 14 so that the output voltage V_{OUT} becomes a desired constant value even though the output current I_{OUT} varies. The inductance value shift control unit 54 has a function to control the operation of the inductance value shifting circuit 40 so that the voltage across the primary-side coil 22 becomes constant even though the input voltage V_{IN} serving as the voltage between terminals of the DC power source 18 varies, and to shift an inductance value of the resonance auxiliary coil 32 in accordance with the input voltage V_{IN}. These functions are realized by the control device 50 executing software. Part of these functions may be realized with hardware.

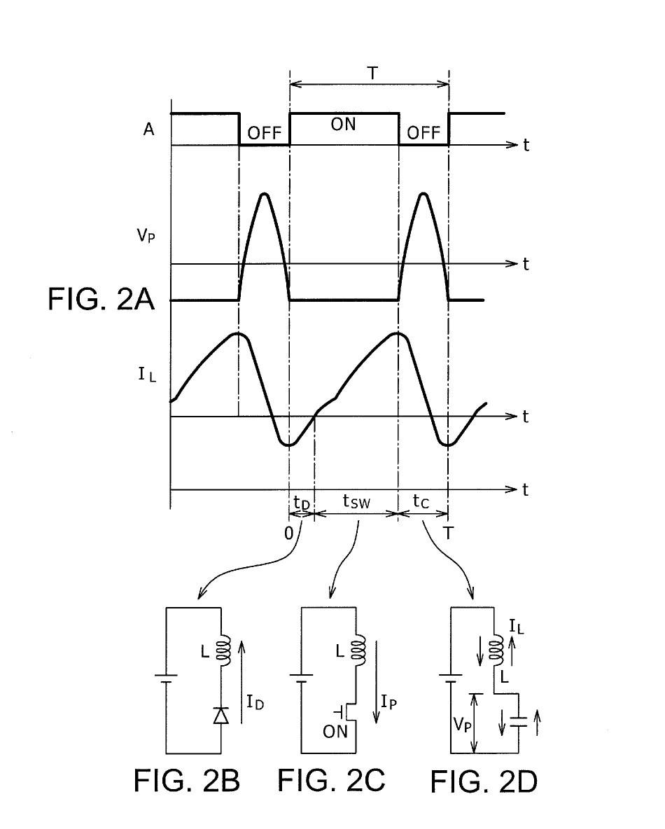

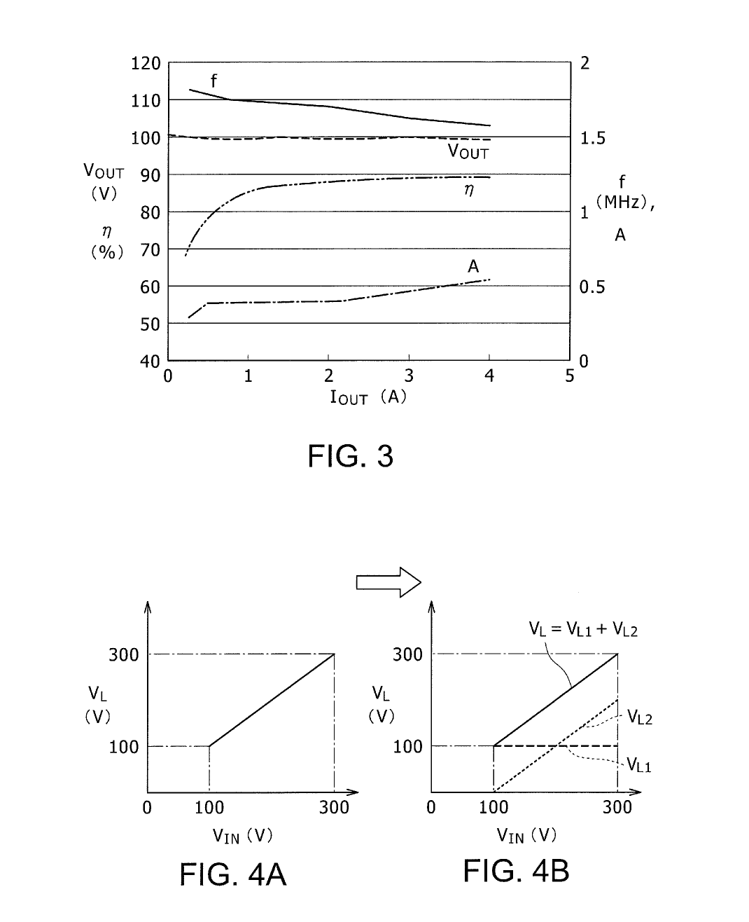

First of all, an operation of the converter 10 when the input voltage V_{IN} does not vary will be described with reference to FIG. 2 and FIG. 3. Then, the contents of the inductance value shifting circuit 40 or the like in the case where the input voltage V_{IN} varies will be described in detail.

FIGS. 2A to 2D are drawings illustrating an operation of the converter 10 when the voltage between terminals of the DC power source 18 is stabilized and the inductance value shifting circuit 40 can be omitted in the configuration illustrated in FIG. 1. In FIG. 2A, a lateral axis indicates time, a vertical axis indicates an ON-OFF state of the switching element 34; that is, a duty ratio A in an uppermost level of the figure, a voltage between drain sources V_{P} of the switching element 34 in a middle level of the figure, and an electric current I_{L} flowing in a resonance coil L=(L1+L2) in a lowermost level of the figure.

The duty ratio A is provided by {ON time/(ON time+OFF time)]. Reference sign T in FIG. 2A denotes one control cycle of the switching element 34, and has a relationship of T=1/f with the operation frequency f of the switching element 34. For example, when f=1 MHz is established, T=1 μs is established. The drain source voltage V_{P} of the switching element 34 is the same as the voltage across the resonance capacitor 38.

FIGS. 2B to 2D are drawings illustrating a flow of electric current when the one control cycle T of the switching element 34 is divided into three. As regards the one control cycle T, t=0 is time when the switching element 34 is turned ON, t=t_{D} is time when the current does not flow to the rectifying device 36, t=(t_{D}+t_{SW}) is time when the switching element 34 is turned OFF, and time T=(t_{D}+t_{SW}+t_{C}) is time when the switching element 34 is turned ON again.

FIG. 2B is a drawing illustrating a flow of the electric current in a period from the time t=0 to the time t=t_{D}. In this period, the switching element 34 is ON. However, in FIG. 2D, which corresponds to the state before, the resonance capacitor 38 discharges electricity, and hence the current I_{L} flows from the ground side to the DC power source 18 side. Therefore, by its nature, the resonance coil L makes an attempt to maintain the direction of flow thereof, so that the current I_{D} flows from the ground side toward the DC power source 18 via the rectifying device 36. In other words, in this period, the current flows to the resonance coil L via the rectifying device 36. At this time, since the current does not flow to the resonance capacitor 38, a voltage between terminals V_{P} of the resonance capacitor C38 is zero.

FIG. 2C is a drawing illustrating a flow of the electric current in a period from the time t=t_{D} to the time t=(t_{D}+t_{SW}). At the time t=t_{D}, a current flowing to the rectifying device 36 becomes zero and, from then onward, a current I_{P} flows via the switching element 34 in the ON state.

FIG. 2D is a drawing illustrating a flow of the electric current in a period from the time t=(t_{D}+t_{SW}) to the time t=T=(t_{D}+t_{SW}+t_{C}). A current flows to the switching element 34 up to the time t=(t_{D}+t_{SW}) and no current flows to the resonance capacitor 38, so that the voltage V_{P} between terminals of the resonance capacitor 38 is zero. The switching element 34 is switched from ON to OFF at the time t=(t_{D}+t_{SW}), such that the current of the switching element 34 is turned OFF. From this moment, LC resonance starts. In other words, the resonance capacitor 38 is charged during this period, and when the voltage between terminals V_{P} of the resonance capacitor 38 becomes maximum, the current flowing in the resonance coil L is inverted and is discharged. A charging-discharging cycle is fixed by a resonance cycle of the resonance coil L and the resonance capacitor 38. Here, the time t=(t_{D}+t_{SW}) is time when charging of the resonance capacitor 38 starts, and time T is time when discharging from the resonance capacitor 38 is terminated. Therefore, the time t=tc corresponds to the time keeping pace with the resonance cycle of the resonance coil L and the resonance capacitor 38.

As illustrated in FIGS. 2B to 2D, when the switching element 34 is turned ON, t=t_{D} is a current I_{L}=0 flowing through the resonance coil L, and when the switching element 34 is turned OFF, (t=t_{D}+t_{SW}) is a drain source voltage V_{P}=0 of the switching element 34. In this manner, turning ON and OFF of the switching element 34 is performed at timing of zero current switching and at timing of zero voltage switching. This control is executed by the switching control unit 52 of the control device 50.

Therefore, one control cycle T of the switching element 34 includes a period of t=(t_{D}+t_{SW}) for flow of a current through the resonance coil L by the switching element 34 separately from t_{c}, which is a period of the resonance frequency determined by the resonance coil L (=L₁+L₂) and a capacitance value C of the resonance capacitor 38. When the output current I_{OUT} is increased, an inductance value L₁ of the primary-side coil 22 is decreased by the transformer 12. Accordingly, the resonance frequency is increased, and hence the period t_{c} of resonance frequency becomes short. In contrast, since the output current I_{OUT} is increased, the period of t=(t_{D}+t_{SW}) during which current flows through the resonance coil L is increased for increasing I_{L} correspondingly for increasing the value I_{L} correspondingly. Consequently, the one control cycle T of the switching element 34 does not change much.

On the other hand, when the output current I_{OUT} decreases, the term t_{c} of resonance frequency is increased, while the period of t=(t_{D}+t_{SW}) during which current flows through the resonance coil L is shortened. Consequently, the one control cycle T of the switching element 34 does not change much in this case as well.

In this manner, in the converter 10 having a configuration illustrated in FIG. 1, if the input voltage V_{IN} does not vary, even though a required value of the output power varies with the variation in load 20, there is little necessity to change the one control cycle T of the switching element 34 and, even if it is necessary, only a small change is required. Therefore, an operating point of the switching element 34 is varied only slightly by a load variation. In contrast, since the operating point of the resonance converter of the related art such as the LLC resonance converter of U.S. Pat. No. 6,344,979 is determined by an LC resonance frequency, a result of study states that the value of the resonance coil L varies if there is a load variation, and hence the LC resonance frequency varies, which increases the width of the drive frequency.

FIG. 3 is a characteristic drawing of a case where the input voltage V_{IN} has no variation in the converter 10 having the configuration illustrated in FIG. 1. Here, the control device 50 detects the output current I_{OUT} of the output circuit 16 by the output current detector 44, and feeds back the detected I_{OUT} together with an output power V_{OUT} detected by the output voltage detector 42, changes the duty ratio A of the switching element 34 so that the output voltage V_{OUT} becomes constant within a range of a desired output current I_{OUT}, and performs control to change the one control cycle T as needed. This control is executed by a function of the switching control unit 52. The input voltage V_{IN}=100 V, which is a constant value.

FIG. 3 is a characteristic drawing illustrating a result of the control. A lateral axis indicates the output current I_{OUT}, and a vertical axis indicates the output voltage V_{OUT}, an operation frequency f of the switching element 34 with respect to the one control cycle T, a duty ratio A, and a conversion efficiency η of the converter 10. As illustrated in FIG. 3, a change of the operation frequency of the switching element 34 when the output voltage V_{OUT} is controlled to a constant value of 100 V is only from approximately 1.57 MHz to approximately 1.83 MHz in a wide range of I_{OUT} from 0.25 A to 4 A. In this manner, the converter 10 having a configuration illustrated in FIG. 1 can perform a stable operation in a high-frequency range over 1 MHz even with a wide load variation if there is no variation in input voltage V_{IN}.

Subsequently, a configuration and an operation of the inductance value shifting circuit 40 when the input voltage V_{IN} varies will be described. FIGS. 4A and 4B are drawings for explaining a problematic point when the input voltage V_{IN} varies, and a basic function of the inductance value shifting circuit 40. FIG. 4A is a drawing illustrating a problematic point when the input voltage V_{IN} varies, and FIG. 4B is a drawing illustrating resolution of the problematic point by using the inductance value shifting circuit 40. In these drawings, the lateral axis indicates the input voltage V_{IN}, and a vertical axis indicates a corresponding voltage V_{L} supplied to the resonance coil L (=L₁+L₂). A high-frequency voltage is supplied to the resonance coil L. However, the magnitude of the amplitude thereof is confirmed to be substantially proportional to the input voltage V_{IN}. The corresponding voltage V_{L} is a value obtained by replacing the magnitude of the high-frequency voltage supplied to the resonance coil L with a voltage value corresponding to the input voltage V_{IN}.

As illustrated in FIG. 4A, if the input voltage V_{IN} is increased due to variations, the current I_{L} flowing in the resonance coil L increases in correspondence to the increase of the variation of the input voltage, and the corresponding voltage V_{L} supplied to the resonance coil L is also increased in correspondence thereto. FIG. 4A illustrates a model showing that if the input voltage V_{IN} is increased from 100 V to 300 V, the value V_{L} also increases from 100 V to 300 V correspondingly. Although 100 V and 300 V are exemplary values, it is considered that the specification of the step-down converter in the hybrid vehicle increases from 100 V to 300 V.

When V_{L} increases in this manner, the amount of increase is distributed proportionally to the primary-side coil 22 and the resonance auxiliary coil 32 in accordance with the inductance value L₁ of the primary-side coil 22 and the inductance value L₂ of the resonance auxiliary coil 32. For example, assuming that L₁:L₂=2:1 is established, if the value V_{L} is increased by an amount corresponding to 200 V, the voltage applied to the primary-side coil 22 is increased by approximately 140 V. The operation of the transformer 12 is determined basically by the number of turns; if the voltage of the primary-side coil 22 varies, the operation of the converter 10 does not work normally. This is a problematic point caused by the variation in V_{IN}.

FIG. 4B is a drawing for solving the above-described problematic points by keeping the corresponding voltage V_{L1} applied to the primary-side coil 22 to a constant value without any variation by imposing the entire part of the variation of the corresponding voltage V_{L} applied to the resonance coil L on variations in a corresponding voltage V_{L2} applied to the resonance auxiliary coil 32. In other words, since V_{L}=V_{L1}+V_{L2} is established, the value of variation of V_{L} becomes ΔV_{L}=ΔV_{L1}+ΔV_{L2}. Here, ΔV_{L}=ΔV_{L2} is satisfied and ΔV_{L1=}0 is established. In order to do so, the inductance value L₂ of the resonance auxiliary coil 32 is shifted so as to correspond to ΔV_{L2}. The device therefor is the inductance value shifting circuit 40, and the inductance value shift control unit 54 of the control device 50 controls the operation of the inductance value shifting circuit 40, and the inductance value L₂ of the resonance auxiliary coil 32 is shifted in accordance with the voltage value V_{IN} of the DC power source 18 so that the voltage V_{L1} across the primary-side coil 22 becomes constant.

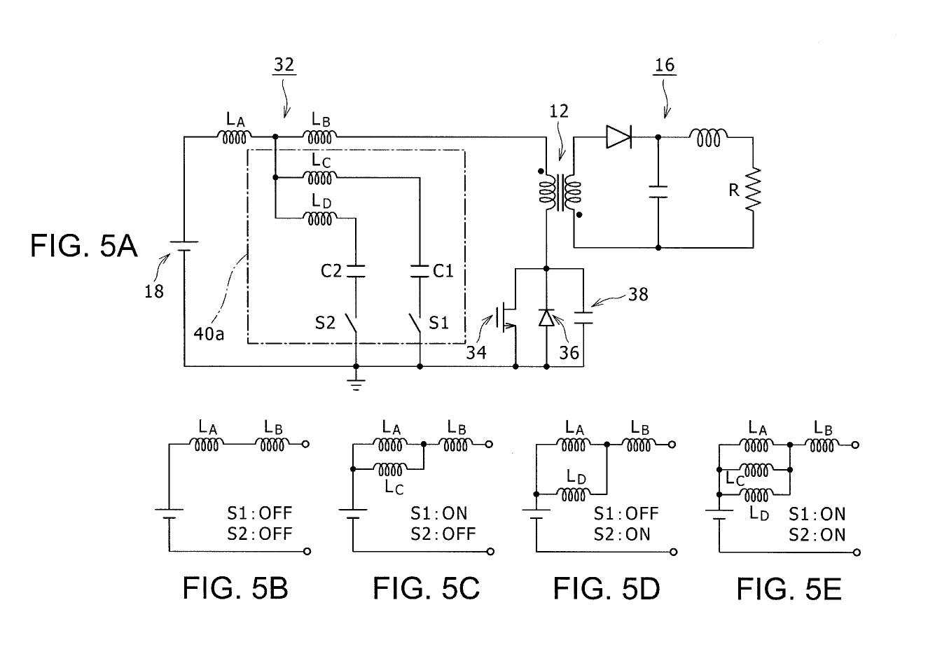

FIG. 5A to FIG. 7 are drawings illustrating inductance value shifting circuits 40a, 40b, and 40c as examples of the inductance value shifting circuit in which the inductance value L2 of the resonance auxiliary coil 32 varies.

FIGS. 5A to 5E are drawings illustrating the inductance value shifting circuit 40a. FIG. 5A illustrates a general configuration drawing of the converter 10 at that time, and FIGS. 5B to 5E illustrate shifting of the inductance value of the resonance auxiliary coil 32. Here, as illustrated in FIG. 5A, the resonance auxiliary coil 32 includes two coils L_{A} and L_{B} connected in series used as basic elements, one side terminal of each of coils L_{C} and L_{D} commonly connected in parallel to the connecting point between the coils L_{A} and L_{B}, and capacitors C1 and C2 and switches S1 and S2 connected respectively to the other side terminals of the coils L_{C} and L_{D} in series and then to the ground. In this configuration, the voltage of the DC power source 18 is applied to the capacitors C1 and C2 when the change-over switches S1 and S2 are ON, whereby the coils connected to the switches S1 and S2 are equivalently connected to the DC power source 18 in parallel. By utilizing this configuration, the inductance value is shifted.

FIG. 5B illustrates a state when the switch S1 and the switch S2 are OFF and the inductance value of the resonance auxiliary coil 32 is (L_{A}+L_{B}).

FIG. 5C illustrates a state when the switch S1 is ON and the switch S2 is OFF. In this case, voltage of the DC power source 18 is applied to the capacitor C1, and hence the voltage of the terminal of the coil Lc on the side of the capacitor C1 becomes the voltage of the DC power source 18, and the coil L_{C} is equivalently connected to the DC power source 18 in parallel. Therefore, the inductance value of the resonance auxiliary coil 32 becomes [1/{(1/L_{A})+(1/L_{C})}]+L_{B}.

FIG. 5D illustrates a state when the switch S2 is ON and the switch S1 is OFF. In this case, voltage of the DC power source 18 is applied to the capacitor C2, and hence the voltage of the terminal of the coil L_{D} on the side of the capacitor C2 becomes the voltage of the DC power source 18, and the coil L_{D} is equivalently connected to the DC power source 18 in parallel. Therefore, the inductance value of the resonance auxiliary coil 32 becomes [1/{(1/L_{A})+(1/L_{D})}]+L_{B}.

FIG. 5E illustrates a state when the switch S1 is ON and the switch S2 is also ON and the inductance value of the resonance auxiliary coil 32 is [1/{(1/L_{A})+(1/L_{C})+(1/L_{D})}]+L_{B}.

In this manner, by using the inductance value shifting circuit 40a and performing the on-off control on the switches S1 and S2 in accordance with the variations of the input voltage V_{IN}, the inductance value of the resonance auxiliary coil 32 can be shifted in four levels. Magnetic coupling may be provided among the coils L_{A}, L_{C}, and L_{D}. The coil L_{B} may also be omitted, depending on the case.

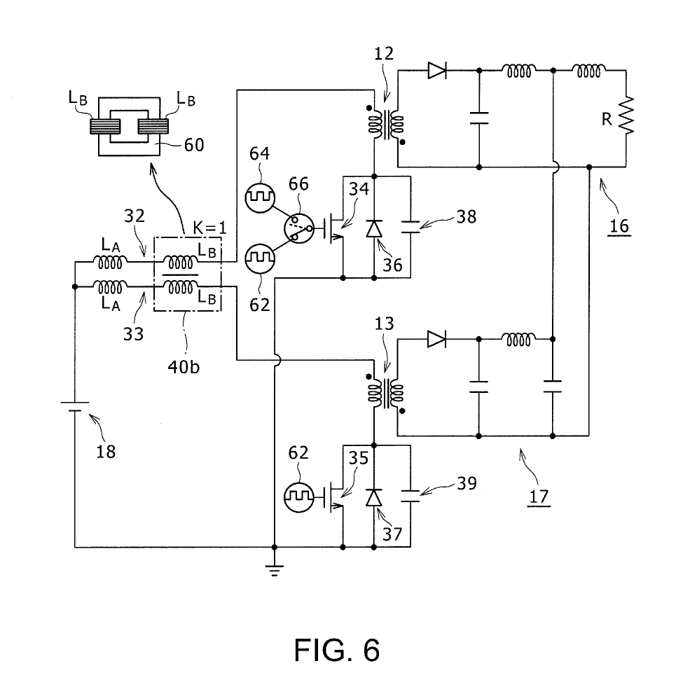

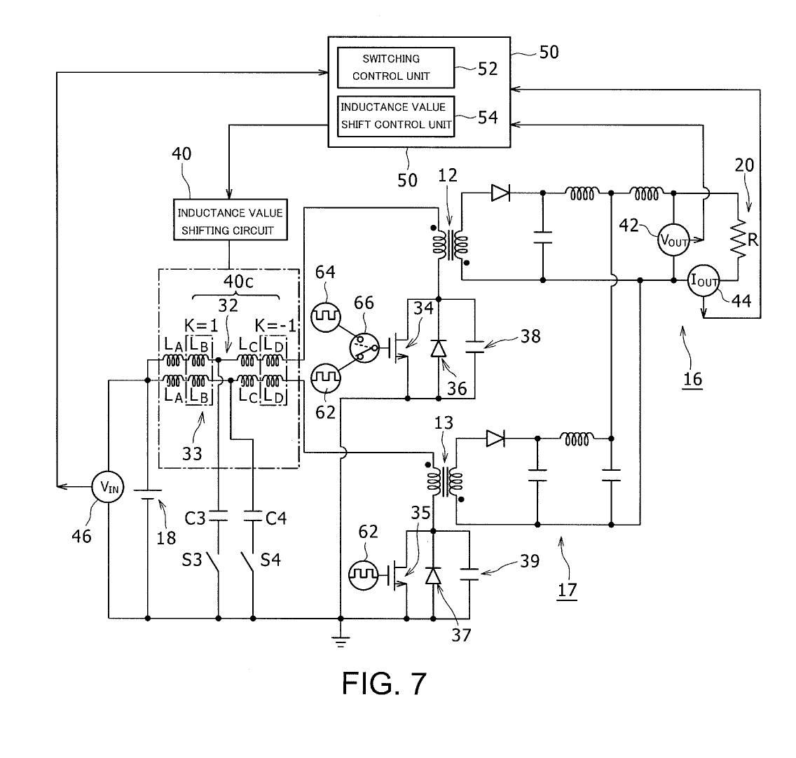

FIG. 6 and FIG. 7 are general configuration drawings including the inductance value shifting circuits 40b and 40c which can be used when the converter 10 has a two-phase configuration. The configuration illustrated in FIG. 6 can shift the inductance value between two values, and the configuration illustrated in FIG. 7 can shift the inductance value among 4 values.

FIG. 6 is a general configuration drawing when the converter 10 has the two-phase configuration, and is composed of one DC power source 18, two input circuits for two phases, two transformers 12 and 13 for two phases, and two output circuits 16 and 17 for two phases. The input circuits for two phases include the resonance auxiliary coil 32, the switching element 34, the rectifying device 36, and the resonance capacitor 38 for the first phase, and a resonance auxiliary coil 33, a switching element 35, a rectifying device 37, and a resonance capacitor 39 for the second phase.

The resonance auxiliary coils 32 and 33 are each composed of the two coils L_{A} and L_{B} connected in series, for both of the first phase and the second phase. However, the coil L_{B} for the first phase and the coil L_{B} for the second phase are wound around the same core 60 and are magnetically coupled. The magnetic coupling is normal coupling (K=1). The drive signal of the switching element 34 for the first phase and the drive signal of the switching element 35 for the second phase have the same duty ratio A and the same operation frequency f, but have a phase difference that can be switched between zero degrees and 180 degrees. In FIG. 6, in contrast to a drive signal 62 of the switching element 35 for the second phase, the drive signal of the switching element 34 for the first phase is configured to be switched by a switching circuit 66 to select which one of the drive signal 62 and a drive signal 64 having a phase difference of 180 degrees therefrom is to be supplied. A magnetically coupled portion of the coil L_{B}, and the portion of the switching circuit 66 correspond to the inductance value shifting circuit 40b.

In the example illustrated in FIG. 6, since the switching element 34 for the first phase receives a supply of the drive signal 62, the phase difference from the drive signal of the switching element 35 for the second phase is zero degrees. In this case, since the coil L_{B} for the first phase and the coil L_{B} for the second phase of the resonance auxiliary coils 32 and 33 are in the state of normal coupling, the inductance values of the resonance auxiliary coils 32 and 33 are both (L_{A}+L_{B}+L_{B})=L_{A}+2L_{B}.

When the switching circuit 66 switches the drive signal to the drive signal 64 having a phase difference of 180 degrees from the drive signal 62, the drive signal 64 of the switching element 34 and the drive signal 62 of the switching element 35 have a phase difference of 180 degrees. In this case, since the coil L_{B} for the first phase and the coil L_{B} for the second phase of the resonance auxiliary coils 32 and 33 are in the state of normal coupling, the coil L_{B} for the first phase and the coil L_{B} for the second phase cancel each other, and the inductance values of the resonance auxiliary coils 32 and 33 are both (L_{A}+L_{B}−L_{B})=L_{A}.

In this manner, by using the inductance value shifting circuit 40b and performing the switching control on the switching circuit 66 in accordance with the variations of the input voltage V_{IN}, the inductance value of the resonance auxiliary coils 32 and 33 can be shifted in two levels of (L_{A}+2L_{B}) and L_{A}.

FIG. 7 has the same configuration as FIG. 6, but the configuration of the resonance auxiliary coils 32 and 33 is different. Here, two sets of magnetically coupled coils are used and coupled in series. In other words, the coils L_{A} and L_{B} connected in series and the coils L_{C} and L_{D} connected in series are connected in series. Here, the coupling of the coil L_{B} for the first phase and the coil L_{B} for the second phase is normal coupling (K=1), and the coupling of the coil L_{D} for the first phase and the coil L_{D} for the second phase is reverse coupling (K=−1). Switches S3 and S4 are connected to the connecting points between the set of the coils L_{A} and L_{B} connected in series and the set of the coils L_{C} and L_{D} connected in series via capacitors C3 and C4, respectively, and are grounded via the switches S3 and S4.

In the resonance auxiliary coil 32 for the first phase, the switch S3 is connected to the connecting point between the coils L_{A} and L_{B} connected in series and the coils L_{C} and L_{D} connected in series via the capacitor C₃ and is grounded on the other side of the switch S3. When the switch S3 is ON, DC current is supplied from the DC power source 18 to the capacitor C₃ via the coils L_{A} and L_{B} connected in series, and AC current generated in the coils L_{C} and L_{D} flows to the ground via the capacitor C3. Therefore, the coils L_{A} and L_{B} connected in series equivalently work as a resistance element, and hence the inductance value becomes zero.

In the same manner, in the resonance auxiliary coil 33 for the second phase, the switch S4 is connected to the connecting point between the coils L_{A} and L_{B} connected in series and the coils L_{C} and L_{D} connected in series via the capacitor C4 and is grounded on the other side of the switch S4. When the switch S4 is ON, DC current is supplied from the DC power source 18 to the capacitor C4 via the coils L_{A} and L_{B} connected in series, and AC current generated in the coils L_{C} and L_{D} flows to the ground via the capacitor C4. Therefore, the coils L_{A} and L_{B} connected in series equivalently work as a resistance element, and hence the inductance value becomes zero.

Magnetically coupled portions of the coils L_{B} and L_{D}, the switching circuit 66, the capacitors C3 and C4, and the switches S3 and S4 correspond to the inductance value shifting circuit 40c.

In the two-phase configuration, the switch S3 and the switch S4 are turned ON and OFF simultaneously. Therefore, when the switches S3 and S4 are OFF, the inductance value of the coils L_{A} and L_{B} connected in series is, since the coil L_{B} is in normal coupling, (L_{A}+L_{B}+L_{B}), which is established when the phase difference is 0 degrees, and (L_{A}+L_{B}−L_{B}) when the phase difference is 180 degrees, in the same manner as in FIG. 6. When the switches S3 and S4 are ON, the inductance value of the coils L_{A} and L_{B} connected in series is zero. In contrast, the inductance value of the coils L_{C} and L_{D} connected in series is, since the coil L_{D} is in reverse coupling, L_{C} when the phase difference is zero degrees, and (L_{C}+L_{D}+L_{D})=L_{C}+2L_{D} is established when the phase difference is 180 degrees.

From the configuration described above, there arise four cases.

(1) A case where the switches S3 and S4 are OFF and the phase difference is zero degrees. At this time, the inductance value of the resonance auxiliary coils 32 and 33 is (L_{A}+L_{B}+L_{B})+L_{C}=L_{A}+2L_{B}+L_{C}.
(2) A case where the switches S3 and S4 are OFF and the phase difference is 180 degrees. At this time, the inductance value of the resonance auxiliary coils 32 and 33 is L_{A}+(L_{C}+L_{D}+L_{D})=L_{A}+L_{C}+2L_{D}.
(3) A case where the switches S3 and S4 are ON and the phase difference is zero degrees. At this time, the inductance value of the resonance auxiliary coils 32 and 33 is L_{C}.
(4) A case where the switches S3 and S4 are ON and the phase difference is 180 degrees. At this time, the inductance value of the resonance auxiliary coils 32 and 33 is L_{C}+2L_{D}.

In this manner, by using the inductance value shifting circuit 40c and performing the switching control on the switching circuit 66 in accordance with the variations of the input voltage V_{IN}, the inductance value of the resonance auxiliary coils 32, 33 can be shifted in four levels.

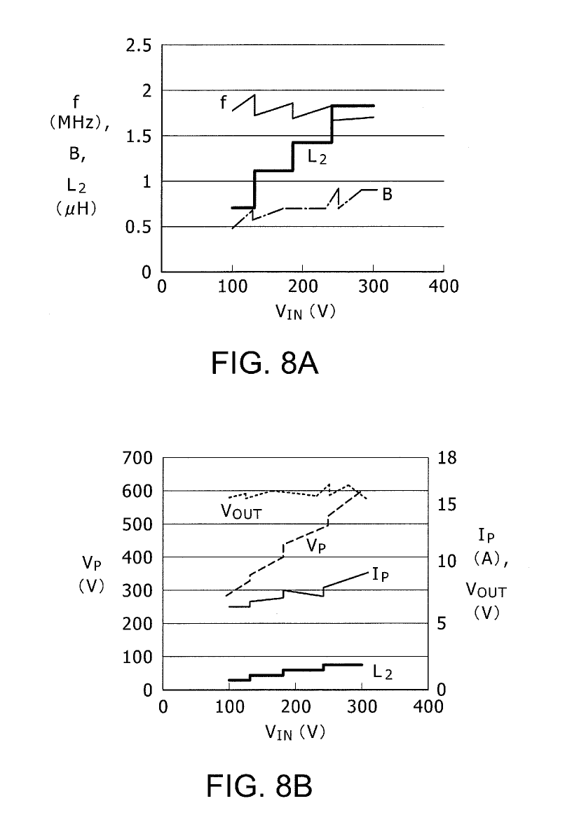

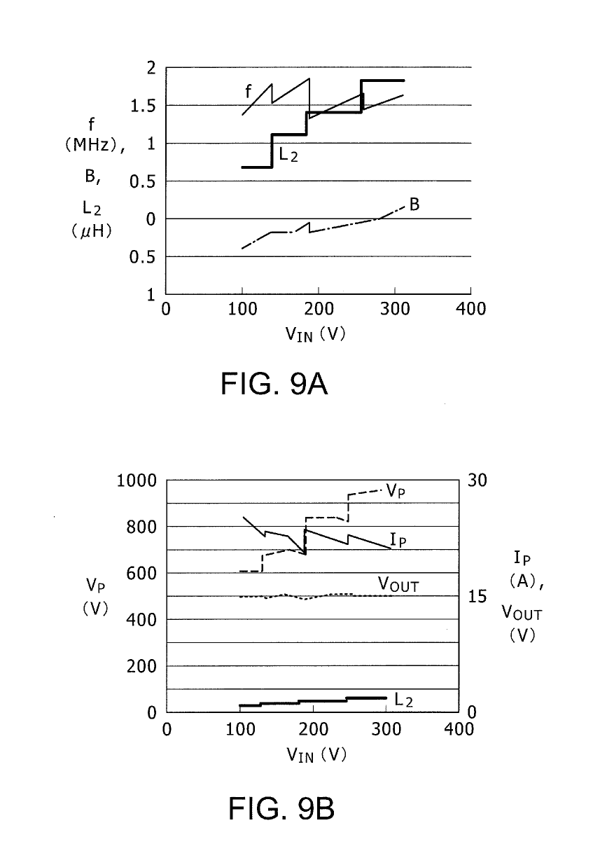

FIG. 8 and FIG. 9 are characteristic drawings of the configuration illustrated in FIG. 7, wherein FIG. 8 illustrates a case where the output current I_{OUT}=1 A, and FIG. 9 illustrates a case where the output current I_{OUT}=100 A. Both are characteristic drawings illustrating a case where the output voltage V_{OUT}=15V is a target voltage. Here, the control device 50 detects the input voltage V_{IN} as the voltage between terminals of the DC power source 18 by the input voltage detector 46, controls the operation of the inductance value shifting circuit 40 in association with the input voltage V_{IN}, and shifts the inductance value of the resonance auxiliary coil 32. On that basis, the control device 50 detects the output current I_{OUT} of the output circuit 16 by the output current detector 44, and feeds back the detected I_{OUT} together with the output power V_{OUT} detected by the output voltage detector 42, changes the duty ratio A of the switching element 34 so that the output voltage V_{OUT} becomes constant under a desired output current I_{OUT}, and, if necessary, performs control to change the one control cycle T. This control is executed by the function of the switching control unit 52 together with the inductance value shift control unit 54.

FIGS. 8A and 8B and FIGS. 9A and 9B are characteristic drawings illustrating the result of the control described above. In these drawings, the lateral axis indicates the input voltage V_{IN}, and the vertical axis indicates the operation frequency f, a control variable B which establishes the duty ratio A={(1−B)/2}, the inductance value L₂ of the resonance auxiliary coils 32 and 33, and the output voltage V_{OUT}. V_{P} corresponds to the maximum value of the voltage between drain sources of the switching element, and I_{P} corresponds to the maximum value of the current of the switching element. As is apparent from these drawings, the value L₂ is shifted step by step in accordance with the variation of the value V_{IN}, and the control to make the output voltage V_{OUT} constant is performed under such a condition. When the output current I_{OUT} in FIG. 8 is 1 A, the operation frequency of the switching elements 34 and 35 can be operated within the range from approximately 1.7 MHz to approximately 1.95 MHz. When the output current I_{OUT} in FIG. 9 is 100 A, the operation range of the switching elements 34 and 35 is from an operation frequency of approximately 1.3 MHz to approximately 1.86 MHz. In this manner, the converter 10 having the configuration illustrated in FIG. 7 can perform a stable operation in a high-frequency range over 1 MHz even with a wide variation in input voltage.

Although the present invention has been fully described by way of examples with reference to the accompanying drawings, it is to be noted that various changes and modifications will be apparent to those skilled in the art. Therefore, unless such changes and modifications depart from the spirit and the scope of the present invention, they should be construed as being included therein.

1. A resonance DC/DC converter comprising: a transformer in which a primary-side coil of an input circuit including an LC resonance circuit and a secondary-side coil of an output circuit are magnetically coupled, wherein
the input circuit includes:
a DC power source having a grounded negative terminal and a positive terminal;
a resonance auxiliary coil connected in series to a point between the positive terminal of the DC power source and one side terminal of the primary-side coil;
a switching element having one switching side terminal connected to the other side terminal of the primary-side coil, another switching side terminal that is connected to ground, and a control terminal;
a rectifying element having a cathode terminal connected to the one switching side terminal of the switching element and an anode terminal connected to the other switching side terminal of the switching element;
a resonance capacitor connected to the one switching side terminal and the other switching side terminal of the switching element in parallel;
an inductance value shifting device configured to shift an inductance value of the resonance auxiliary coil; and
a control circuit configured to control the inductance value shifting device and shift the inductance value of the resonance auxiliary coil in accordance with a voltage value of the DC power source so that a voltage across the primary-side coil is kept constant.

2. The resonance DC/DC converter according to claim 1, wherein
the inductance value shifting device is configured to connect one side terminal of each of a plurality of coils commonly to the resonance auxiliary coil or the primary-side coil,
the other side terminal of one coil is connected to a positive side of the DC power source and connects a capacitor and a change-over switch in series to each of the other side terminals of the remaining coils respectively and then to the ground, so that the voltage of the DC power source is applied to the capacitor when the change-over switch is ON, whereby the coil connected to the change-over switch is equivalently connected to the DC power source in parallel.

3. The resonance DC/DC converter according to claim 1, wherein
the input circuit and the output circuit have a two-phase configuration, and
the inductance value shifting device magnetically couples the resonance auxiliary coils of the input circuits of the respective phases to each other, and shifts an equivalent inductance value of the resonance auxiliary coil by switching a phase difference of the input signals of the switching elements of the input circuits of the respective phases between zero degrees and 180 degrees.

4. The resonance DC/DC converter according to claim 3, wherein
the inductance value shifting device is configured in such a manner that the resonance auxiliary coils of the respective phases each have a plurality of coils connected in series, is configured to connect each of connecting points of the plurality of coils to the capacitor and the change-over switch in series and then to the ground, and shift the inductance value among a plurality of values by ON-OFF control of a plurality of the change-over switches.

5. The resonance DC/DC converter according to claim 1, wherein
an output voltage from the output circuit is fed back and the frequency of the switching element is changed so that the output voltage becomes constant within a desired output current range, and the inductance value of the resonance auxiliary coil is shifted on the basis of the output current from the output circuit and the input voltage of the input circuit.

6. The resonance DC/DC converter according to claim 2, wherein
an output voltage from the output circuit is fed back and the frequency of the switching element is changed so that the output voltage becomes constant within a desired output current range, and the inductance value of the resonance auxiliary coil is shifted on the basis of the output current from the output circuit and the input voltage of the input circuit.

7. The resonance DC/DC converter according to claim 3, wherein
an output voltage from the output circuit is fed back and the frequency of the switching element is changed so that the output voltage becomes constant within a desired output current range, and the inductance value of the resonance auxiliary coil is shifted on the basis of the output current from the output circuit and the input voltage of the input circuit.

8. The resonance DC/DC converter according to claim 4, wherein
an output voltage from the output circuit is fed back and the frequency of the switching element is changed so that the output voltage becomes constant within a desired output current range, and the inductance value of the resonance auxiliary coil is shifted on the basis of the output current from the output circuit and the input voltage of the input circuit.
